(19) United States
(12) Patent Application Publication
(10) Pub. No.: US 2016/0159949 A1
(43) Pub. Date: Jun. 9, 2016

(54) SOLUTION POLYMERIZATION PROCESS

(71) Applicant: NOVA Chemicals (International) S.A., Fribourg (CH)

(72) Inventors: Peter Zoricak, Calgary (CA); Peter Phung Minh Hoang, Calgary (CA)

(73) Assignee: NOVA Chemicals (International) S.A., Fribourg (CH)

(21) Appl. No.: 15/046,767

(22) Filed: Feb. 18, 2016

Related U.S. Application Data
(63) Continuation-in-part of application No. 14/447,720, filed on Jul. 31, 2014, now Pat. No. 9,321,859.
Application No. 14/447,720 is a continuation-in-part of application No. 13/200,144, filed on Sep. 19, 2011, now Pat. No. 8,952,111.

(30) Foreign Application Priority Data
Jun. 9, 2011 (CA) 2742461

(51) Int. Cl. C08F 210/16

(52) U.S. Cl. CPC C08F 210/16

(57) ABSTRACT

A Solution polymerization process for the (co) polymerization of ethylene is conducted in the presence of i) a phosphinimine catalyst; ii) a co catalyst, and iii) a long chain amine modifier.

### CROSS REFERENCE TO RELATED PATENT APPLICATIONS

This application is a continuation-in-part of U.S. patent application Ser. No. 14/447,720 filed on Jul. 31, 2014 which is a continuation-in-part of U.S. patent application Ser. No. 13/200,144, filed on Sep. 19, 2011, which was granted as U.S. Pat. No. 8,952,111 on Feb. 10, 2015 and which claims priority to and the benefit of Canadian Patent Application No. 2,742,461, filed Jun. 9, 2011.

Catalyst modifiers comprise at least one long chain amine and are employed in combination with a phosphinimine polymerization catalyst in a solution polymerization process.

Amine modifiers have been used in slurry and gas phase polymerization processes. European Patent Application No. 630,910 discusses reversibly reducing the activity of a metallocene catalyst using a Lewis base compound such as for example an amine compound.

Long chain substituted alkanolamine compounds in particular, have been used in combination with metallocenes to reduce the amount of reactor fouling in fluidized bed polymerization processes. The use of substituted alkanolamines in combination with metallocene catalysts to improve reactor operability and reduce static levels is described in European Patent Application No. 811,638 and in U.S. Pat. Nos. 5,712,352; 6,201,076; 6,476,165; 6,180,729; 6,977,283; 6,114,479; 6,140,432; 6,124,230; 6,117,955; 5,763,543; and 6,180,736. Alkanolamines have been added to a metallocene catalyst prior to addition to a reaction zone, as described in U.S. Pat. Nos. 6,140,432; 6,124,230 and 6,114,479. Alkanolamines have also been added directly to a reactor or other associated parts of a fluidized bed reactor processes such as the recycle stream loop as is taught in European Patent Application No. 811,638 and in U.S. Pat. No. 6,180,729, respectively.

The present invention is directed to the use of a catalyst modifier comprising at least one long-chain amine in a solution polymerization process.

Provided is a process for polymerizing ethylene and optionally an alpha olefin in a solution reactor with a polymerization catalyst comprising: i) a phosphinimine catalyst; ii) a cocatalyst; and iii) a catalyst modifier; wherein the catalyst modifier comprises at least one long-chain amine compound.

In an embodiment of the invention, a catalyst modifier comprises at least one compound represented by the formula: R¹N((CH₂)ₙOH)((CH₂)ₘOH) where R¹ is a hydrocarbyl group having anywhere from 5 to 30 carbon atoms, and n and m are integers from 1-20.

In an embodiment of the invention, a catalyst modifier comprises at least one compound represented by the formula: R¹N((CH₂)ₙOH)₂ where R¹ is an hydrocarbyl group having anywhere from 6 to 30 carbon atoms, and n is an integer from 1-20.

In an embodiment of the invention, a catalyst modifier comprises at least one compound represented by the formula: R¹N(CH₂CH₂OH)₂ where R¹ is a hydrocarbyl group having anywhere from 6 to 30 carbon atoms.

In an embodiment of the invention, the catalyst modifier is defined by the formula R^{a}R^{b}R^{c} wherein R^{a} and R^{b} are each independently a C₆ to C₃₀ hydrocarbyl and R^{c} is selected from hydrogen and C₁ to C₃₀ hydrocarbyl.

In an embodiment of the invention, a phosphinimine catalyst has the formula: (L)(Pl)MX₂, where M is Ti, Zr or Hf; Pl is a phosphinimine ligand having the formula R₃P═N—, where R is independently selected from hydrogen, halogen, and C₁-C₂₀ hydrocarbyl; L is a ligand selected from cyclopentadienyl, substituted cyclopentadienyl, indenyl, substituted indenyl, fluorenyl, and substituted fluorenyl; and X is an activatable ligand.

In an embodiment of the invention, a cocatalyst is selected from ionic activators, alkylaluminoxanes and mixtures thereof.

### The Catalyst Modifier

The catalyst modifier employed in the present invention comprises a long chain amine compound. In the present invention, the terms “long chain substituted amine” or “long chain amine” are defined as tri-coordinate nitrogen compounds (i.e., amine based compounds) containing at least one hydrocarbyl group having at least 5 carbon atoms, or, for example, from 6 to 30 carbon atoms. The terms “hydrocarbyl” or “hydrocarbyl group” includes branched or straight chain hydrocarbyl groups which may be fully saturated groups (i.e., have no double or triple bonding moieties) or which may be partially unsaturated (i.e., they may have one or more double or triple bonding moieties). The long chain hydrocarbyl group may also contain un-saturation in the form of aromatic ring moieties attached to or part of the main chain. In one embodiment, the long chain amine (i.e., the tri-coordinate nitrogen compound) will also have at least one heteroatom containing hydrocarbyl group. Such heteroatom containing hydrocarbyl groups can be branched or straight chain hydrocarbyl groups or substituted hydrocarbyl groups having one or more carbon atoms and at least one heteroatom. Heteroatom containing hydrocarbyl groups may also contain unsaturated moieties. Suitable heteroatoms include for example, oxygen, nitrogen, phosphorus or sulfur. Other groups which may be attached to nitrogen in a long chain substituted amine compound are generally selected from hydrocarbyl groups having one or more carbon atoms and/or a hydrogen group (H).

In embodiments of the invention, the long chain amine is a long chain substituted monoalkanolamine, or a long chain substituted dialkanolamine. These amines have one or two alcoholhydrocarbyl groups respectively as well as a hydrocarbyl group having at least 5 carbons.

In an embodiment of the invention, the catalyst modifier employed comprises at least one long chain amine compound represented by the formula: R¹R²ₓN((CH₂)ₙOH)_{y} where R¹ is a hydrocarbyl group having from 5 to 30 carbon atoms, R² is hydrogen or a hydrocarbyl group having from 1 to 30 carbon atoms, x is 1 or 0, y is 1 when x is 1, y is 2 when x is 0, each n is independently an integer from 1 to 30 when y is 2, and n is an integer from 1 to 30 when y is 1.

In an embodiment of the invention, the catalyst modifier comprises at least one long chain substituted monoalkanolamine represented by the formula R¹R²N((CH₂)ₙOH) where R¹ is a hydrocarbyl group having anywhere from 5 to 30 carbon atoms, R² is a hydrogen or a hydrocarbyl group having anywhere from 1 to 30 carbon atoms, and n is an integer from 1-20.

In an embodiment of the invention, the catalyst modifier comprises at least one long chain substituted dialkanolamine represented by the formula: R¹N((CH₂)ₙOH)((CH₂)ₘOH) where R¹ is a hydrocarbyl group having anywhere from 5 to 30 carbon atoms, and n and m are integers from 1-20.

In an embodiment of the invention, the catalyst modifier comprises at least one long chain substituted dialkanolamine represented by the formula: R¹N((CH₂)ₙOH)₂ where R¹ is a hydrocarbyl group having anywhere from 6 to 30 carbon atoms, and n is an integer from 1-20.

In an embodiment of the invention, the catalyst modifier comprises at least one long chain substituted dialkanolamine represented by the formula: R¹N((CH₂)ₙOH)₂ where R¹ is a hydrocarbyl group having anywhere from 6 to 30 carbon atoms, and n is 2 or 3.

In an embodiment of the invention, the catalyst modifier comprises at least one long chain substituted dialkanolamine represented by the formula: R¹N((CH₂)ₙOH)₂ where R¹ is a linear hydrocarbyl group having anywhere from 6 to 30 carbon atoms, and n is 2 or 3.

In an embodiment of the invention, the catalyst modifier comprises at least one long chain substituted dialkanolamine represented by the formula: R¹N(CH₂CH—₂OH)₂ where R¹ is a linear hydrocarbyl group having anywhere from 6 to 30 carbon atoms.

In an embodiment of the invention, the catalyst modifier comprises at least one long chain substituted dialkanolamine represented by the formula: R¹N(CH₂CH—₂OH)₂ where R¹ is a linear, saturated alkyl group having anywhere from 6 to 30 carbon atoms.

In an embodiment of the invention, the catalyst modifier comprises at least one long chain substituted dialkanolamine represented by the formula: R¹N(CH₂CH₂OH)₂ where R¹ is a hydrocarbyl group having anywhere from 8 to 22 carbon atoms.

In an embodiment of the invention, the catalyst modifier comprises a long chain substituted dialkanolamine represented by the formula: C₁₈H₃₇N(CH₂CH₂OH)₂.

In an embodiment of the invention, the catalyst modifier comprises long chain substituted dialkanolamines represented by the formulas: C₁₃H₂₇N(CH₂CH₂OH)₂ and C₁₅H₃₁N(CH₂CH₂OH)₂.

In an embodiment of the invention, the catalyst modifier comprises a mixture of long chain substituted dialkanolamines represented by the formula: R¹N(CH₂CH₂OH)₂ where R¹ is a hydrocarbyl group having anywhere from 8 to 18 carbon atoms.

Non limiting examples of catalyst modifiers which can be used in the present invention are Kemamine AS-990™, Kemamine AS-650™, Armostat-1800™, bis-hydroxy-cocoamine, 2,2′-octadecyl-amino-bisethanol, and Atmer-163™.

The long chain substituted amine may also be a polyoxyethylene-hydrocarbyl amine.

In an embodiment of the invention, the catalyst modifier comprises a polyoxyethylenehydrocarbyl amine represented by the formula: R¹N((CH₂CH₂O)ₙH)((CH₂CH₂O)ₘH), where R¹ is a hydrocarbyl group having from 5 to 30 carbons, and n and m are integers from 1-10 or higher (i.e. polymeric).

### The Polymerization Catalyst

In the present invention, the (olefin) polymerization catalyst comprises: i) a phosphinimine catalyst, ii) a cocatalyst, and iii) a catalyst modifier.

### The Phosphinimine Catalyst

Some non-limiting examples of phosphinimine catalysts can be found in U.S. Pat. Nos. 6,342,463; 6,235,672; 6,372,864; 6,984,695; 6,063,879; 6,777,509 and 6,277,931 all of which are incorporated by reference herein.

In one embodiment, the phosphinimine catalyst is based on metals from group 4, which includes titanium, hafnium and zirconium. In some embodiments, the most preferred phosphinimine catalysts are group 4 metal complexes in their highest oxidation state.

The phosphinimine catalysts described herein, usually require activation by one or more cocatalytic or activator species in order to provide polymer from olefins.

A phosphinimine catalyst is a compound (typically an organometallic compound) based on a group 3, 4 or 5 metal and which is characterized as having at least one phosphinimine ligand. Any compounds/complexes having a phosphinimine ligand and which display catalytic activity for ethylene (co) polymerization may be called “phosphinimine catalysts”.

In an embodiment of the invention, a phosphinimine catalyst is defined by the formula: (L)ₙ(Pl)ₘMXₚ where M is a transition metal selected from Ti, Hf, Zr; PI is a phosphinimine ligand; L is a cyclopentadienyl-type ligand or a heteroatom ligand; X is an activatable ligand; m is 1 or 2; n is 0 or 1; and p is determined by the valency of the metal M. In one embodiment, m is 1, n is 1 and p is 2.

In an embodiment of the invention, a phosphinimine catalyst is defined by the formula: (L)(Pl)MX₂ where M is a transition metal selected from Ti, Hf, Zr; Pl is a phosphinimine ligand; L is a cyclopentadienyl type ligand; and X is an activatable ligand.

The phosphinimine ligand is defined by the formula: R₃P═N—, where N bonds to the metal, and wherein each R is independently selected from a hydrogen atom; a halogen atom; C₁₋₂₀ hydrocarbyl radicals which are unsubstituted or further substituted by one or more halogen atom and/or C₁₋₂₀ alkyl radical; C₁₋₈ alkoxy radical; C₆₋₁₀ aryl or aryloxy radical (the aryl or aryloxy radical optionally being unsubstituted or further substituted by one or more halogen atom and/or C₁₋₂₀ alkyl radical); amido radical; silyl radical of the formula: —SiR′₃ wherein each R′ is independently selected from hydrogen, a C₁₋₈ alkyl or alkoxy radical, C₆₋₁₀ aryl or aryloxy radicals; and germanyl radical of the formula: —GeR′₃ wherein R′ is as defined above.

In an embodiment of the invention, the phosphinimine ligand is chosen so that each R is a hydrocarbyl radical. In a particular embodiment of the invention, the phosphinimine ligand is tri-(tertiarybutyl)phosphinimine (i.e., where each R is a tertiary butyl group, or “t-Bu” for short).

In an embodiment of the invention, the phosphinimine catalyst is a group 4 compound/complex which contains one phosphinimine ligand (as described above) and one ligand L which is either a cyclopentadienyl-type ligand or a heteroatom ligand.

As used herein, the term “cyclopentadienyl-type” ligand is meant to include ligands which contain at least one five-carbon ring which is bonded to the metal via eta-5 (or in some cases eta-3) bonding. Thus, the term “cyclopentadienyl-type” includes, for example, unsubstituted cyclopentadienyl, singly or multiply substituted cyclopentadienyl, unsubstituted indenyl, singly or multiply substituted indenyl, unsubstituted fluorenyl and singly or multiply substituted fluorenyl. Hydrogenated versions of indenyl and fluorenyl ligands are also contemplated for use in the current invention, so long as the five-carbon ring which bonds to the metal via eta-5 (or in some cases eta-3) bonding remains intact. Substituents for a cyclopentadienyl ligand, an indenyl ligand (or hydrogenated version thereof) and a fluorenyl ligand (or hydrogenated version thereof) may be selected from a C₁₋₃₀ hydrocarbyl radical (which hydrocarbyl radical may be unsubstituted or further substituted by, for example, a halide and/or a hydrocarbyl group; for example a suitable substituted C₁₋₃₀ hydrocarbyl radical is a pentafluorobenzyl group such as —CH₂C₆F₅); a halogen atom; a C₁₋₈ alkoxy radical; a C₆₋₁₀ aryl or aryloxy radical (each of which may be further substituted by for example a halide and/or a hydrocarbyl group; for example a suitable C₆₋₁₀ aryl group is a perfluoroaryl group such as —C₆F₅); an amido radical which is unsubstituted or substituted by up to two C₁₋₈ alkyl radicals; a phosphido radical which is unsubstituted or substituted by up to two C₁₋₈ alkyl radicals; a silyl radical of the formula —Si(R′)₃ wherein each R′ is independently selected from hydrogen, a C₁₋₈ alkyl or alkoxy radical, C₆₋₁₀ aryl or aryloxy radicals; and a germanyl radical of the formula —Ge(R′)₃ wherein R′ is as defined directly above.

As used herein, the term “heteroatom ligand” refers to a ligand which contains at least one heteroatom selected from boron, nitrogen, oxygen, silicon, phosphorus or sulfur. The heteroatom ligand may be sigma or pi-bonded to the metal. Exemplary heteroatom ligands include but are not limited to “silicon containing” ligands, “amido” ligands, “alkoxy” ligands, “boron heterocycle” ligands and “phosphole” ligands.

Silicon containing ligands are defined by the formula: —(μ)SiR^{x}R^{y}R^{z} where the “—” denotes a bond to the transition metal and p is sulfur or oxygen. The substituents on the Si atom, namely R^{x}, R^{y} and R^{z} are required in order to satisfy the bonding orbital of the Si atom. The use of any particular substituent R^{x}, R^{y} or R^{z} is not especially important. In an embodiment of the invention, each of R^{x}, R^{y} and R^{z} is a C₁₋₂ hydrocarbyl group (i.e. methyl or ethyl) simply because such materials are readily synthesized from commercially available materials.

The term “amido” is meant to convey its broad, conventional meaning. Thus, these ligands are characterized by (a) a metal-nitrogen bond and (b) the presence of two substituents (which are typically simple alkyl or silyl groups) on the nitrogen atom.

The term “alkoxy” is also intended to convey its conventional meaning. Thus, these ligands are characterized by (a) a metal oxygen bond, and (b) the presence of a hydrocarbyl group bonded to the oxygen atom. The hydrocarbyl group may be a ring structure and may optionally be substituted (e.g., 2,6 di-tertiary butyl phenoxy).

The “boron heterocyclic” ligands are characterized by the presence of a boron atom in a closed ring ligand. This definition includes heterocyclic ligands which also contain a nitrogen atom in the ring. These ligands are well known to those skilled in the art of olefin polymerization and are fully described in the literature (see, for example, U.S. Pat. Nos. 5,637,659 and 5,554,775 and the references cited therein).

The term “phosphole” is also meant to convey its conventional meaning. “Phospholes” are cyclic dienyl structures having four carbon atoms and one phosphorus atom in the closed ring. The simplest phosphole is C₄PH₄ (which is analogous to cyclopentadiene with one carbon in the ring being replaced by phosphorus). The phosphole ligands may be substituted with, for example, C₁₋₂₀ hydrocarbyl radicals (which may, optionally, contain halogen substituents); phosphido radicals; amido radicals; silyl or alkoxy radicals. Phosphole ligands are also well known to those skilled in the art of olefin polymerization and are described as such in U.S. Pat. No. 5,434,116.

The term “activatable ligand” refers to a ligand which may be activated by a cocatalyst (also referred to as an “activator”), to facilitate olefin polymerization. An activatable ligand X may be cleaved from the metal center M via a protonolysis reaction or abstracted from the metal center M by suitable acidic or electrophilic catalyst activator compounds (also known as “co-catalyst” compounds) respectively, examples of which are described below. The activatable ligand X may also be transformed into another ligand which is cleaved or abstracted from the metal center M (e.g., a halide may be converted to an alkyl group). Without wishing to be bound by any single theory, protonolysis or abstraction reactions generate an active “cationic” metal center which can polymerize olefins. In embodiments of the present invention, the activatable ligand, X is independently selected from a hydrogen atom; a halogen atom; a C₁₋₁₀ hydrocarbyl radical; a C₁₋₁₀ alkoxy radical; a C₆₋₁₀ aryl oxide radical, each of which said hydrocarbyl, alkoxy, and aryl oxide radicals may be unsubstituted by or further substituted by a halogen atom, a C₁₋₈ alkyl radical, a C₁₋₈ alkoxy radical, a C₆₋₁₀ aryl or aryloxy radical; an amido radical which is unsubstituted or substituted by up to two C₁₋₈ alkyl radicals; and a phosphido radical which is unsubstituted or substituted by up to two C₁₋₈ alkyl radicals. Two activatable X ligands may also be joined to one another and form for example, a substituted or unsubstituted diene ligand (i.e., 1,3-diene); or a delocalized heteroatom containing group such as an acetate group.

The number of activatable ligands depends upon the valency of the metal and the valency of the activatable ligand. In some embodiments, the preferred phosphinimine catalysts are based on group 4 metals in their highest oxidation state (i.e., 4⁺). Particularly suitable activatable ligands are monoanionic such as a halide (e.g. chloride) or a hydrocarbyl (e.g., methyl, benzyl).

In some instances, the metal of the phosphinimine catalyst may not be in the highest oxidation state. For example, a titanium (III) component would contain one activatable ligand.

In an embodiment of the invention, the phosphinimine catalyst has the formula, (L)(Pl)MX₂, where M is Ti, Zr or Hf; PI is a phosphinimine ligand having the formula R₃P═N—, where R is independently selected from hydrogen, halogen, and C₁-C₂₀ hydrocarbyl; L is a ligand selected from cyclopentadienyl, substituted cyclopentadienyl, indenyl, substituted indenyl, fluorenyl, and substituted fluorenyl; and X is an activatable ligand.

In an embodiment of the invention, the phosphinimine catalyst has the formula, (L)(PI)MX₂, where M is Ti, Zr or Hf; PI is a phosphinimine ligand having the formula R₃P═N—, where R is independently selected from hydrogen, halogen, and C₁-C₂₀ hydrocarbyl; L is a substituted cyclopentadienyl ligand; and X is an activatable ligand.

In an embodiment of the invention, the phosphinimine catalyst has the formula, (L)((t-Bu)₃P═N)MX₂, where M is Ti, Zr or Hf; L is a substituted cyclopentadienyl ligand; and X is an activatable ligand.

In an embodiment of the invention, the phosphinimine catalyst contains a phosphinimine ligand, a cyclopentadienyl ligand (“Cp” for short) and two chloride or two methyl ligands bonded to the group 4 metal.

In an embodiment of the invention, the phosphinimine catalyst contains a phosphinimine ligand, a substituted cyclopentadienyl ligand and two chloride or two methyl ligands bonded to the group 4 metal.

In an embodiment of the invention, the phosphinimine catalyst contains a phosphinimine ligand, a perfluoroaryl substituted cyclopentadienyl ligand and two chloride or two methyl ligands bonded to the group 4 metal.

In an embodiment of the invention, the phosphinimine catalyst contains a phosphinimine ligand, a perfluorophenyl substituted cyclopentadienyl ligand (i.e. Cp-C₆F₅) and two chloride or two methyl ligands bonded to the group 4 metal.

In an embodiment of the invention, the phosphinimine catalyst contains a 1,2-substituted cyclopentadienyl ligand and a phosphinimine ligand which is substituted by three tertiary butyl substituents.

In an embodiment of the invention, the phosphinimine catalyst contains a 1,2 substituted cyclopentadienyl ligand (e.g., a 1,2-(R*)(Ar—F)Cp) where the substituents are selected from R* a hydrocarbyl group, and Ar—F a perfluorinated aryl group, a 2,6 (i.e., ortho) fluoro substituted phenyl group, a 2,4,6 (i.e., ortho/para) fluoro substituted phenyl group, or a 2,3,5,6 (i.e., ortho/meta) fluoro substituted phenyl group respectively.

In the present invention, 1,2 substituted cyclopentadienyl ligands such as for example 1,2-(R*)(Ar—F)Cp ligands may contain as impurities 1,3 substituted analogues such as for example 1,3-(R*)(Ar—F)Cp ligands. Hence, phosphinimine catalysts having a 1,2 substituted Cp ligand may contain as an impurity, a phosphinimine catalyst having a 1,3 substituted Cp ligand. Alternatively, the current invention contemplates the use of 1,3 substituted Cp ligands as well as the use of mixtures of varying amounts of 1,2 and 1,3 substituted Cp ligands to give phosphinimine catalysts having 1,3 substituted Cp ligands or mixed phosphinimine catalysts having 1,2 and 1,3 substituted Cp ligands.

In an embodiment of the invention, the phosphinimine catalyst has the formula: (1,2-(R*)(Ar—F)Cp)M(N═P(t-Bu)₃)X₂ where R* is a hydrocarbyl group; Ar—F is a perfluorinated aryl group, a 2,6 (i.e., ortho) fluoro substituted phenyl group, a 2,4,6 (i.e., ortho/para) fluoro substituted phenyl group, or a 2,3,5,6 (i.e., ortho/meta) fluoro substituted phenyl group; M is Ti, Zr or Hf; and X is an activatable ligand. In an embodiment of the invention, the phosphinimine catalyst has the formula: (1,2-(R*)(Ar—F)Cp)M(N═P(t-Bu)₃)X₂ where R* is an alkyl group; Ar—F is a perfluorinated aryl group, a 2,6 (i.e., ortho) fluoro substituted phenyl group, a 2,4,6 (i.e., ortho/para) fluoro substituted phenyl group or a 2,3,5,6 (i.e., ortho/meta) fluoro substituted phenyl group; M is Ti, Zr or Hf; and X is an activatable ligand. In an embodiment of the invention, the phosphinimine catalyst has the formula: (1,2-(R*)(Ar—F)Cp)M(N═P(t-Bu)₃)X₂ where R* is a hydrocarbyl group having from 1 to 20 carbons; Ar—F is a perfluorinated aryl group; M is Ti, Zr or Hf; and X is an activatable ligand. In an embodiment of the invention, the phosphinimine catalyst has the formula: (1,2-(R*)(Ar—F)Cp)M(N═P(t-Bu)₃)X₂ where R* is a straight chain alkyl group; Ar—F is a perfluorinated aryl group, a 2,6 (i.e., ortho) fluoro substituted phenyl group, a 2,4,6 (i.e., ortho/para) fluoro substituted phenyl group, or a 2,3,5,6 (i.e., ortho/meta) fluoro substituted phenyl group; M is Ti, Zr or Hf; and X is an activatable ligand. In an embodiment of the invention, the phosphinimine catalyst has the formula: (1,2-(n-R*)(Ar—F)Cp)Ti(N═P(t-Bu)₃)X₂ where R* is a straight chain alkyl group; Ar—F is a perfluorinated aryl group; M is Ti, Zr or Hf; and X is an activatable ligand. In an embodiment of the invention, the phosphinimine catalyst has the formula: (1,2-(R*)(C₆F₅)Cp)M(N═P(t-Bu)₃)X₂ where R* is a hydrocarbyl group having 1 to 20 carbon atoms; M is Ti, Zr or Hf; and X is an activatable ligand. In an embodiment of the invention, the phosphinimine catalyst has the formula: (1,2-(n-R″)(C₆F₅)Cp)M(N═P(t-Bu)₃)X₂ where R* is a straight chain alkyl group; M is Ti, Zr or Hf; and X is an activatable ligand. In further embodiments, M is Ti and R* is selected from n-propyl, n-butyl and n-hexyl, and X is selected from chloride or methide. In further embodiments, M is Ti and R* is any one of a methyl, ethyl, n-propyl, n-butyl, n-pentyl, n-hexyl, n-heptyl, and n-octyl group. In further embodiments, X is chloride or methide.

The term “perfluorinated aryl group” means that each hydrogen atom attached to a carbon atom in an aryl group has been replaced with a fluorine atom as is well understood in the art (e.g., a perfluorinated phenyl group or substituent has the formula —C₆F₅). In embodiments of the invention, Ar—F is selected from the group comprising perfluorinated phenyl or perfluorinated naphthyl groups.

Some phosphinimine catalysts which may be used in the present invention include: ((C₆F₅)Cp)Ti(N═P(t-Bu)₃)Cl₂; (1,2-(n-propyl)(C₆F₅)Cp)Ti(N═P(t-Bu)₃)Cl₂, (1,2-(n-butyl)(C₆F₅)Cp)Ti(N═P(t-Bu)₃)Cl₂ and (1,2-(n-hexyl)(C₆F₅)Cp)Ti(N═P(t-Bu)₃)Cl₂; ((C₆F₅)Cp)Ti(N═P(t-Bu)₃)Me₂, (Cp)Ti(N═P(t-Bu)₃)Cl₂ and (Cp)Ti(N═P(t-Bu)₃)Me₂.

### The Cocatalyst

In the present invention, the phosphinimine catalyst is used in combination with at least one activator (or “cocatalyst”) to form an active polymerization catalyst system for olefin polymerization. Activators (i.e., cocatalysts) include ionic activator cocatalysts and hydrocarbyl aluminoxane cocatalysts.

The activator used to activate the phosphinimine catalyst can be any suitable activator including one or more activators selected from alkylaluminoxanes and ionic activators, optionally together with an alkylating agent.

The alkylaluminoxanes are complex aluminum compounds of the formula:

R³₂Al¹O(R³Al¹O)ₘAl¹R³₂, wherein each R³ is independently selected from C₁₋₂₀ hydrocarbyl radicals and m is from 3 to 50. Optionally a hindered phenol can be added to the alkylaluminoxane to provide a molar ratio of Al¹:hindered phenol of from 2:1 to 5:1 when the hindered phenol is present.

In an embodiment of the invention, R³ of the alkylaluminoxane, is a methyl radical and m is from 10 to 40.

The alkylaluminoxanes are typically used in substantial molar excess compared to the amount of group 4 transition metal in the phosphinimine catalyst. The Al¹:group 4 transition metal molar ratios are from 10:1 to 10,000:1, or, for example, about 30:1 to 500:1.

It is well known in the art, that the alkylaluminoxane can serve dual roles as both an alkylator and an activator. Hence, an alkylaluminoxane activator is often used in combination with activatable ligands such as halogens. Commercially available alkylaluminoxane activators include MAO (methylaluminoxane) and MMAO (modified methylaluminoxane).

Alternatively, the activator of the present invention may be a combination of an alkylating agent (which may also serve as a scavenger) with an activator capable of ionizing the group 4 metal of the phosphinimine catalyst (i.e., an ionic activator). In this context, the activator can be chosen from one or more alkylaluminoxane and/or an ionic activator.

When present, the alkylating agent may be selected from (R⁴)ₚMgX²₂₋ₚ wherein X² is a halide and each R⁴ is independently selected from C₁₋₁₀ alkyl radicals and p is 1 or 2; R⁴Li wherein in R⁴ is as defined above, (R⁴)_{q}ZnX²_{2-q} wherein R⁴ is as defined above, X² is halogen and q is 1 or 2; (R⁴)ₛAl²X²₃₋ₛ wherein R⁴ is as defined above, X² is halogen and s is an integer from 1 to 3. In some embodiments in the above compounds, R⁴ is a C₁₋₄ alkyl radical, and X² is chlorine. Commercially available compounds include triethyl aluminum (TEAL), diethyl aluminum chloride (DEAC), dibutyl magnesium ((Bu)₂Mg), and butyl ethyl magnesium (BuEtMg or BuMgEt).

In an embodiment, the ionic activator may be selected from the group consisting of: (i) compounds of the formula [R⁵]⁺ [B(R⁶)₄]⁻ wherein B is a boron atom, R⁵ is a cyclic C₅₋₇ aromatic cation or a triphenyl methyl cation and each R⁶ is independently selected from phenyl radicals which are unsubstituted or substituted with from 3 to 5 substituents selected from a fluorine atom, a C₁₋₄ alkyl or alkoxy radical which is unsubstituted or substituted by a fluorine atom; and a silyl radical of the formula —Si—(R⁷)₃; wherein each R⁷ is independently selected from a hydrogen atom and a C₁₋₄ alkyl radical; and (ii) compounds of the formula [(R⁸)ₜZH]⁺ [B(R⁶)₄]⁻ wherein B is a boron atom, H is a hydrogen atom, Z is a nitrogen atom or phosphorus atom, t is 2 or 3 and R⁸ is selected from C₁₋₃₀ alkyl radicals (with the proviso that at least one R⁸ contains from 6 to 0 carbon atoms), a phenyl radical which is unsubstituted or substituted by up to three C₁₋₄ alkyl radicals, and R⁶ is as defined above; and (iii) compounds of the formula B(R⁶)₃ wherein R⁶ is as defined above.

In some embodiments, in the above compounds R⁶ is a pentafluorophenyl radical, and R⁵ is a triphenylmethyl cation, Z is a nitrogen atom and R⁸ is a C₁₋₄ alkyl radical or one R⁸ taken together with a nitrogen atom forms an anilinium radical (e.g., PhR⁸₂NH⁺, which is substituted by two R⁸ radicals such as for example two C₁₋₄ alkyl radicals).

Examples of compounds capable of ionizing the phosphinimine catalyst include the following compounds: triethylammonium tetra(phenyl)boron, tripropylammonium tetra(phenyl)boron, tri(n-butyl)ammonium tetra(phenyl)boron, trimethylammonium tetra(p-tolyl)boron, trimethylammonium tetra(o-tolyl)boron, tributylammonium tetra(pentafluorophenyl)boron, tripropylammonium tetra(o,p-dimethylphenyl)boron, tributylammonium tetra(m,m-dimethylphenyl)boron, tributylammonium tetra(p-trifluoromethylphenyl)boron, tributylammonium tetra(pentafluorophenyl)boron, tri(n-butyl)ammonium tetra(o-tolyl)boron, N,N-dimethylanilinium tetra(phenyl)boron, N,N-diethylanilinium tetra(phenyl)boron, N,N-diethylanilinium tetra(phenyl)n-butylboron, N,N-2,4,6-pentamethylanilinium tetra(phenyl)boron, di-(isopropyl)ammonium tetra(pentafluorophenyl)boron, dicyclohexylammonium tetra(phenyl)boron, triphenylphosphonium tetra)phenyl)boron, tri(methylphenyl)phosphonium tetra(phenyl)boron, tri(dimethylphenyl)phosphonium tetra(phenyl)boron, tropillium tetrakispentafluorophenyl borate, triphenylmethylium tetrakispentafluorophenyl borate, benzene (diazonium) tetrakispentafluorophenyl borate, tropillium phenyltris-pentafluorophenyl borate, triphenylmethylium phenyl-trispentafluorophenyl borate, benzene (diazonium) phenyltrispentafluorophenyl borate, tropillium tetrakis(2,3,5,6-tetrafluorophenyl)borate, triphenylmethylium tetrakis(2,3,5,6-tetrafluorophenyl)borate, benzene (diazonium) tetrakis(3,4,5-trifluorophenyl)borate, tropillium tetrakis(3,4,5-trifluorophenyl)borate, benzene (diazonium) tetrakis(3,4,5-trifluorophenyl)borate, tropillium tetrakis(1,2,2-trifluoroethenyl)borate, trophenylmethylium tetrakis(1,2,2-trifluoroethenyl)borate, benzene (diazonium) tetrakis(1,2,2-trifluoroethenyl)borate, tropillium tetrakis(2,3,4,5-tetrafluorophenyl)borate, triphenylmethylium tetrakis(2,3,4,5-tetrafluorophenyl)borate, and benzene (diazonium) tetrakis(2,3,4,5-tetrafluorophenyl)borate; N,N-bisoctadecyl methylammonium tetrakis(pentafluorophenyl)borate).

Commercially available activators which are capable of ionizing the group 4 metal of the phosphinimine catalyst include: N,N-dimethylaniliniumtetrakispentafluorophenyl borate (“[Me₂NHPh][B(C₆F₅)₄]”); triphenylmethylium tetrakispentafluorophenyl borate (“[Ph₃C][B(C₆F₅)₄]”); and trispentafluorophenyl boron.

The ionic activators compounds may be used in amounts which provide a molar ratio of group 4 transition metal to boron that will be from 1:1 to 1:6.

Optionally, mixtures of alkylaluminoxanes and ionic activators can be used as activators in the polymerization catalyst.

Optionally, scavengers are added to the polymerization process. The present invention can be carried out in the presence of any suitable scavenger or scavengers. Scavengers are well known in the art.

In an embodiment of the invention, scavengers are organoaluminum compounds having the formula: Al³(X³)ₙ(X⁴)₃₋ₙ, where (X³) is a hydrocarbyl having from 1 to about 20 carbon atoms; (X⁴) is selected from alkoxide or aryloxide, any one of which having from 1 to about 20 carbon atoms; halide; or hydride; and n is a number from 1 to 3, inclusive; or hydrocarbyl aluminoxanes having the formula: R³₂Al¹O(R³Al¹O)ₘAl¹R³₂

wherein each R³ is independently selected from C₁₋₂₀ hydrocarbyl radicals and m is from 3 to 50. Some non-limiting preferred scavengers useful in the current invention include triisobutylaluminum, triethylaluminum, trimethylaluminum or other trihydrocarbyl aluminum compounds.

The scavenger may be used in any suitable amount but by way of non-limiting examples only, can be present in an amount to provide a molar ratio of Al:M (where M is the metal of the phosphinimine catalyst) of from about 20 to about 2000, or from about 50 to about 1000, or from about 100 to about 500.

### Polyethylene Copolymer

The polymer compositions made using the present invention are, for example, copolymers of ethylene and one or more an alpha olefin(s).

In an embodiment of the invention, an alpha olefin selected for polymerization with ethylene can be one or more alpha olefins selected from 1-butene, 1-hexene and 1-octene.

In embodiments of the invention, the copolymer composition will comprise at least 75 weight % of ethylene units, or at least 80 wt % of ethylene units, or at least 85 wt % of ethylene units with the balance being an alpha-olefin unit, based on the weight of the copolymer composition.

Polymer properties such as average molecular weight (e.g., Mw, Mn and Mz), molecular weight distribution (i.e. Mw/Mn), density, melt indices (e.g., I₂, I₅, I₂₁, I₁₀), melt index or melt flow ratios (e.g., I₂₁/I₂, I₂₁/I₅), comonomer distribution breadth index (CDBI), TREF-profile, comonomer distribution profile, and the like as these terms are defined further below and in for example co-pending CA Patent Application No. 2,734,167 (to the same Applicant) are not specifically defined, but by way of non-limiting example only, the polymer compositions made using the present invention, may have a density of from 0.910 g/cc to 0.93 g/cc, a melt index of from 0.25 to 10.0 g/10 min, a melt flow ratio (I₂₁/I₂) of less than 20, a weight average molecular weight of from 25,000 to 300,000, and a unimodal or bimodal TREF profile.

In embodiments of the invention, the copolymer will have a melt index of from 0.1 to 5.0 g/10 min, or from 0.25 to 5.0 g/10 min, or from 0.25 to 4.5 g/10 min, or from 0.25 to 4.0 g/10 min, or from 0.25 to 3.5 g/10 min, or from 0.25 to 3.0 g/10 min, or from 0.75 to 5.0 g/10 min, or from 0.75 to 4.5 g/10 min, or from 0.75 to 4.0 g/10 min, or from 0.75 to 3.5 g/10 min, or from 0.25 to 3 g/10 min, or from 0.25 to 2.5 g/10 min, or from 0.5 to 2.0 g/10 min, or from 0.75 to 1.5 g/10 min.

In embodiments of the invention, the copolymer will have a density of from 0.910 g/cm³ to 0.930 g/cm³, or from 0.911 g/cm³ to 0.930 g/cm³, or from 0.912 g/cm³ to 0.930 g/cm³, or from 0.910 g/cm³ to 0.927 g/cm³, or from 0.910 g/cm³ to 0.925 g/cm³, or from 0.910 g/cm³ to 0.920 g/cm³, or from 0.911 g/cm³ to 0.927 g/cm³, or from 0.911 g/cm³ to 0.925 g/cm³, or from 0.911 g/cm³ to 0.920 g/cm³, or from 0.916 g/cm³ to 0.930 g/cm³, from 0.916 g/cm³ to 0.927 g/cm³, or from 0.916 g/cm³ to 0.925 g/cm³, or from 0.916 g/cm³ to 0.920 g/cm³, from 0.917 g/cm³ to 0.927 g/cm³, or from 0.917 g/cm³ to 0.925 g/cm³, or from 0.917 g/cm³ to 0.920 g/cm³.

In an embodiment of the invention, the polymer composition will have a density of greater than 0.911 g/cm³ and lower than 0.925 g/cm³.

In an embodiment of the invention, the copolymer will have a unimodal profile in a gel permeation chromatography (GPC) curve generated according to the method of ASTM D6474-99. The term “unimodal” is herein defined to mean there will be one significant peak or maximum evident in the GPC-curve. In contrast, by the term “bimodal” it is meant that there will be a secondary peak or shoulder which represents a higher or lower molecular weight component (i.e., the molecular weight distribution, can be said to have two maxima in a molecular weight distribution curve). Alternatively, the term “multi-modal” denotes the presence of more than two maxima in a molecular weight distribution curve generated according to the method of ASTM D6474-99.

In embodiments of the invention, the copolymer will have a molecular weight distribution (M_{w}/Mₙ) as determined by gel permeation chromatography (GPC) of less than 3.0, or less than 2.7, or from 1.6 to 2.6, or from 1.7 to 2.5, or from 1.7 to 2.4, or from 1.7 to 2.3, or from 1.7 to 2.2, or from 1.8 to 2.4, or from 1.8 to 2.3, or from 1.8 to 2.2.

In yet another embodiment of the invention, the copolymer will have a molecular weight distribution (Mw/Mn) of ≦2.5. In still another embodiment of the invention, the copolymer will have a molecular weight distribution (M_{w}/Mₙ) of ≦2.4. In yet another embodiment of the invention, the copolymer will have a molecular weight distribution (M_{w}/Mₙ) of ≦2.3. In yet further embodiments of the invention, the copolymer will have a molecular weight distribution (M_{w}/Mₙ) of ≦2.2, or ≦2.1, or ≦2.0.

In embodiments of the invention, the copolymers of the invention will exhibit a weight average molecular weight (Mw) as determined by gel permeation chromatography (GPC) of from 30,000 to 250,000, or from 50,000 to 200,000, or from 50,000 to 175,000, or from 75,000 to 150,000, or from 80,000 to 125,000.

In an embodiment of the invention, the copolymer will have a flat comonomer incorporation profile as measured using Gel-Permeation Chromatography with Fourier Transform Infra-Red detection (GPC-FTIR). In an embodiment of the invention, the copolymer will have a negative (i.e. “normal”) comonomer incorporation profile as measured using GPC-FTIR. In an embodiment of the invention, the copolymer will have an inverse (i.e., “reversed”) or partially inverse comonomer incorporation profile as measured using GPC-FTIR. If the comonomer incorporation decreases with molecular weight, as measured using GPC-FTIR, the distribution is described as “normal” or “negative”. If the comonomer incorporation is approximately constant with molecular weight, as measured using GPC-FTIR, the comonomer distribution is described as “flat”. The terms “reversed comonomer distribution” and “partially reversed comonomer distribution” mean that in the GPC-FTIR data obtained for the copolymer, there is one or more higher molecular weight components having a higher comonomer incorporation than in one or more lower molecular weight segments. If the comonomer incorporation rises with molecular weight, the distribution is described as “reversed”. Where the comonomer incorporation rises with increasing molecular weight and then declines, the comonomer distribution is described as “partially reversed”.

In an embodiment of the invention, the copolymer will have a melt flow ratio (the MFR=I₂₁/I₂) of less than 20, or less than 18, or less than 17, or less than 16.5. In further embodiments of the invention, the copolymer will have an I₂₁/I₂ of from 10 to 19.5, or from 11 to 19, or from 14 to 19, or from 13 to 17, or from 14 to 17, or from 14 to 16.5.

In embodiments of the invention, the copolymer will have a comonomer distribution breadth index (CDBI₅₀), as determined by temperature elution fractionation (TREF), of at least 40 weight percent (wt %), or at least 50 wt %, or at least 60 wt %, or at least 65 wt %, or at least 70 wt %, or at least 75 wt %. In further embodiments of the invention, the copolymer will have a comonomer distribution breadth index (CDBI₅₀), as determined by temperature elution fractionation (TREF) of from 40 wt % to 85 wt %, or from 45 wt % to 85 wt %, or from 50 wt % to 85 wt %, or from 55 wt % to 80 wt %, or from 60 wt % to 80 wt %, or from 60 wt % to 75 wt %, or from 65 wt % to 75 wt %.

In embodiments of the invention, the copolymer will have a CY a-parameter (also called the Carreau-Yasuda shear exponent) of from 0.4 to 1.0, or from 0.5 to 0.9, or from 0.5 to 0.8.

In an embodiment of the invention, the copolymer will have a bimodal TREF profile.

In an embodiment of the invention, the copolymers will have a TREF profile, as measured by temperature rising elution fractionation, comprising: a primary peak at a temperature T1; a secondary peak at a temp T2; and from 1 to 30 wt % of the copolymer is represented at a temperature of from 90° C.; wherein T2>T1 and the difference in temperature between T1 and T2 is less than 30° C. By the term “primary” peak, it is meant that the peak corresponds to an elution intensity maximum in a TREF profile which corresponds to a majority fraction of the copolymer. By the term “secondary” peak, it is meant that the peak corresponds to an elution intensity maximum in a TREF profile which corresponds to a minority fraction of the copolymer. Hence, for clarity, the primary and secondary peaks have a maximum which occurs at temperatures T1 and T2 respectively.

In embodiments of the invention, the difference in temperature between T1 and T2 will be ≦30° C., or ≦20° C., or ≦15° C., or ≦10° C.

In embodiments of the invention, less than 30 wt %, or less than 25 wt %, or less than 20 wt %, or less than 15 wt %, or less than 10 wt %, or less than 7.5 wt % of the copolymer will be represented within a temperature range of from 90° C. to 105° C. in a TREF profile. In an embodiment of the invention, from 1 to 30 wt % of the copolymer will be represented within a temperature range of from 90° C. to 105° C. in a TREF profile. In another embodiment of the invention, from 3 to 25 wt % of the copolymer will be represented at a temperature range of from 90° C. to 105° C. in a TREF profile. In yet another embodiment of the invention, from 5 to 25 wt % of the copolymer will be represented at a temperature range from 90° C. to 105° C. in a TREF profile. In yet another embodiment of the invention, from 3 to 20 wt % of the copolymer will be represented at a temperature range from 90° C. to 105° C. in a TREF profile. In a further embodiment of the invention, from 5 to 20 wt % of the copolymer will be represented at a temperature range of from 90° C. to 105° C. in a TREF profile. In still another embodiment of the invention, from 10 to 25 wt % of the copolymer will be represented at a temperature from 90° C. to 105° C. in a TREF profile. In still yet another embodiment of the invention, from 10 to 20 wt % of the copolymer will be represented at a temperature of from 90° C. to 105° C. in a TREF profile.

In an embodiment of the invention, T2 is greater than 90° C.

In an embodiment of the invention, T1 is in the range of from 70 to 90° C. and T2 is in the range of 85 to 100° C., provided that T2 is greater than T1.

In an embodiment of the invention, T1 is in the range of from 80 to 90° C. and T2 is in the range of 90 to 100° C., provided that T2 is greater than T1.

In embodiments of the invention, the copolymer will have a hexane extractables level of ≦1.0 wt %, or ≦0.75 wt %, or ≦0.5 wt %, or <0.5 wt %, or <0.4 wt %, or ≦0.3 wt %. In an embodiment of the invention, the copolymer has a hexane extractables level of from 0.1 to 0.3 wt %.

In an embodiment of the present invention, the copolymer will have little or no long chain branching. Without wishing to be bound by any single theory, the melt index ratio, I₁₀/I₂ and its comparison with M_{w}/Mₙ for a given copolymer may be a useful proxy for the presence of long chain branching. Ethylene copolymers which have low I₁₀/I₂ ratios (i.e. of below about 7.0) and which satisfy the relationship I₁₀/I₂−4.63<M_{w}/Mₙ are consistent with low levels or an absence of long chain branching (see European Patent No. 751,967).

In an embodiment of the present invention, the copolymer will have a melt index ratio, I₁₀/I₂ value of ≦7.0. In other embodiments of the invention, the copolymer will have an I₁₀/I₂ of ≦6.5, or ≦6.0.

In an embodiment of the present invention, the copolymer will satisfy the relationship I₁₀/I₂−4.63<M_{w}/Mₙ.

### Catalyst Modifier Addition

The amount of catalyst modifier added to a reactor (or other associated process equipment) is conveniently represented herein as the parts per million (ppm) of catalyst modifier based on the weight of copolymer produced.

The amount of catalyst modifier included in a polymerization catalyst is conveniently represented herein as a weight percent (wt %) of the catalyst modifier based on the combined weight of the phosphinimine catalyst and the cocatalyst. In order to avoid any ambiguity, the phrase “weight of the polymerization catalyst” includes the weight of the phosphinimine catalyst and the cocatalyst, but not the weight of the catalyst modifier.

The total amount of catalyst modifier included in the polymerization catalyst can range anywhere from about 0.1 to 10 weight percent (or smaller ranges within this range) based on the combined weight of the phosphinimine catalyst and the cocatalyst.

In an embodiment of the invention, the polymerization catalyst comprises: i) a phosphinimine catalyst; ii) a cocatalyst (including the aluminoxane, if present); and iii) a catalyst modifier; wherein the catalyst modifier comprises a “long chain amine” compound as described above in “The Catalyst Modifier” section and which is present in from 0.25 to 6.0 weight percent based on the weight of i), ii) and iii) of the polymerization catalyst.

In an embodiment of the invention, the polymerization catalyst comprises: i) a phosphinimine catalyst; ii) a cocatalyst; and iii) a catalyst modifier; wherein the catalyst modifier is present from 0.25 to 6.0 weight percent based on the weight of i), ii) and iii) of the polymerization catalyst and comprises a compound having the formula: R¹R²ₓN((CH₂)ₙOH)_{y} where R¹ is a hydrocarbyl group having from 5 to 30 carbon atoms, R² is hydrogen or a hydrocarbyl group having from 1 to 30 carbon atoms, x is 1 or 0, y is 1 when x is 1, y is 2 when x is 0, each n is independently an integer from 1 to 30 when y is 2, and n is an integer from 1 to 30 when y is 1.

In an embodiment of the invention, the polymerization process is carried out in the presence of a polymerization catalyst comprising: i) a phosphinimine catalyst; ii) a cocatalyst; and iii) a catalyst modifier; wherein the catalyst modifier is present from 0.25 to 6.0 weight percent based on the weight of i), ii) and iii) of the polymerization catalyst and comprises a compound having the formula: R¹R²ₓN((CH₂)ₙOH)_{y} where R¹ is a hydrocarbyl group having from 5 to 30 carbon atoms, R² is hydrogen or a hydrocarbyl group having from 1 to 30 carbon atoms, x is 1 or 0, y is 1 when x is 1, y is 2 when x is 0, each n is independently an integer from 1 to 30 when y is 2, and n is an integer from 1 to 30 when y is 1.

In an embodiment of the invention, the polymerization process is carried out in the presence of a polymerization catalyst comprising: i) a phosphinimine catalyst; ii) a cocatalyst; and iii) a catalyst modifier; wherein the catalyst modifier is present from 0.25 to 5.0 weight percent based on the weight of i), ii) and iii) of the polymerization catalyst and comprises a compound having the formula: R¹R²ₓN((CH₂)ₙOH)_{y} where R¹ is a hydrocarbyl group having from 5 to 30 carbon atoms, R² is hydrogen or a hydrocarbyl group having from 1 to 30 carbon atoms, x is 1 or 0, y is 1 when x is 1, y is 2 when x is 0, each n is independently an integer from 1 to 30 when y is 2, and n is an integer from 1 to 30 when y is 1.

In an embodiment of the invention, a polymerization process comprises polymerizing ethylene and an alpha olefin in a solution reactor in the presence of a polymerization catalyst to give a polyethylene copolymer having a density of from 0.910 g/cm³ to 0.927 g/cm³, a melt index (I₂) of from 0.25 to 5.0 g/10 min, a melt flow ratio (I₂₁/I₂)<20, and a molecular weight distribution (M_{w}/Mₙ)≦3.0; where the polymerization catalyst comprises: i) a phosphinimine catalyst; ii) a cocatalyst; and iii) a catalyst modifier; and where the catalyst modifier is present in from 0.25 to 6.0 weight percent based on the weight of i), ii) and iii) of the polymerization catalyst and comprises a compound having the formula: R¹R²ₓN((CH₂)ₙOH)_{y} where R¹ is a hydrocarbyl group having from 5 to 30 carbon atoms, R² is hydrogen or a hydrocarbyl group having from 1 to 30 carbon atoms, x is 1 or 0, y is 1 when x is 1, y is 2 when x is 0, each n is independently an integer from 1 to 30 when y is 2, and n is an integer from 1 to 30 when y is 1.

The presence of a catalyst modifier in the polymerization catalyst may also affect the properties of ethylene copolymers produced during polymerization of ethylene and an alpha-olefin as well as the properties of films made with those copolymers.

Ethylene copolymers can be defined by a composition distribution breadth index (CDBI₅₀), which is a measure as to how comonomers are distributed in an ethylene copolymer. The definition of composition distribution breadth index (CDBI₅₀) can be found in U.S. Pat. No. 5,206,075 and PCT publication WO 93/03093. The CDBI₅₀ is conveniently determined using techniques which isolate polymer fractions based on their solubility (and hence their comonomer content). For example, temperature rising elution fractionation (TREF) as described by Wild et al. J. Poly. Sci., Poly. Phys. Ed. Vol. 20, p441, 1982 can be employed. From the weight fraction versus composition distribution curve, the CDBI₅₀ is determined by establishing the weight percentage of a copolymer sample that has a comonomer content within 50% of the median comonomer content on each side of the median. Generally, ethylene copolymers with a CDBI₅₀ of less than about 50%, are considered “heterogeneously branched” copolymers with respect to the short chain branching. Such heterogeneously branched materials may include a highly branched fraction, a medium branched fraction and a higher density fraction having little or no short chain branching. In contrast, ethylene copolymers with a CDBI₅₀ of greater than about 50% are considered “homogeneously branched” copolymers with respect to short chain branching in which the majority of polymer chains may have a similar degree of branching.

### EXAMPLES

### Example 1

### Part B: Solution Polymerization

### The Continuous Solution Polymerization

All the polymerization experiments described below were conducted on a continuous solution polymerization reactor. The process is continuous in all feed streams (solvent, monomers and catalyst) and in the removal of product. All feed streams were purified prior to the reactor by contact with various absorption media to remove catalyst killing impurities such as water, oxygen and polar materials as is known to those skilled in the art. All components were stored and manipulated under an atmosphere of purified nitrogen.

All the examples below were conducted in a reactor of 75 cc internal volume. In each experiment the volumetric feed to the reactor was kept constant and as a consequence so was the reactor residence time.

The catalyst solutions were pumped to the reactor independently but there was contact between the activator and the catalyst before they entered the reactor. The polymerizations were carried out in cyclohexane at a pressure of 1500 psi. Ethylene was supplied to the reactor by a calibrated thermal mass flow meter at the rates shown in the Tables and was dissolved in the reaction solvent prior to the polymerization reactor. Under these conditions the monomer conversion is a dependent variable controlled by the catalyst concentration, reaction temperature and catalyst activity, etc.

The internal reactor temperature is monitored by a thermocouple in the polymerization medium and can be controlled at the required set point to +/−0.5° C. Downstream of the reactor the pressure was reduced from the reaction pressure (1500 psi) to atmospheric.

The ethylene conversion was determined by a dedicated on line gas chromatograph by reference to propane which was used as an internal standard. The average polymerization rate constant was calculated based on the reactor hold-up time, the catalyst concentration in the reactor and the ethylene conversion and is expressed in l/(mmol*min).

where: Q is the percent ethylene conversion; [M] is the catalyst (metal) concentration in the reactor expressed in mM; and HUT is the reactor hold-up time in minutes.

The catalyst used in all experiments was a titanium (IV) complex having one cyclopentadienyl ligand, two methyl ligands and one tri(tertiary butyl)phosphinimine ligand (“CpTiNP(tBu)₃Me”). The cocatalysts were a commercially available methylalumoxane (“MAO”) and a commercially available borate (“Ph₃CB(C₆F₅)₄”). A hindered phenol (2,6 di-tertiary butyl, 4-ethyl, phenol) was also used.

The molar ratios of the catalyst components follow:

### Al/Ti: 80/1

### B/Ti: 1.2/1

### OH/Al: 0.3/1

The flow rate of ethylene to the reaction was 3.5 grams per minute.

The titanium concentration in the reactor was 0.8 to 1.1 μM.

The experiments were conducted at a temperature of 190° C.

Experiment 1-C is a control/comparative experiment using the phosphinimine catalyst system described above. As shown in Table 1, this catalyst system produced a polymer having a weight average molecular weight (Mw) of about 4.7×10⁴ at a catalyst productivity of about 2.4×10⁶ grams of polymer per gram of Ti. Inventive experiment 2 was conducted in the presence of a long chain amine (sold under the trademark ATMER 163) at a mole ratio of 1.2/1 on the basis of the titanium in the catalyst (i.e. N/Ti ratio=1.2/1). Expressed differently, the weight % of the amine as a percentage of the total catalyst composition is 1%. As shown in Table 1, the long chain amine did not have an adverse impact upon the catalyst productivity or polymer molecular weight under these conditions.

Inventive experiment 3 was conducted in same manner as experiment 2 except a different long chain amine (sold under the trade name ARMOSTAT 1800) was used. The weight % of ARMOSTAT 1800 (based on the total catalyst composition) was 1.2%. As shown in Table 1, this amine did not have an adverse impact upon the catalyst productivity or the molecular weight of the polymer. In addition, the Mw/Mn of all polymers was observed to be less than 2 (not shown in Table 1).

Stable operating conditions were observed for both of inventive experiments 2 and 3 and there was no visual evidence of any reactor.

TABLE 1

| | | | | | Produc- | | |
|---|---|---|---|---|---|---|---|
| | Atmer | Armostat | | Kp | tivity | | |
| | 163:Ti | 1800:Ti | | (L/ | (gPE/ | Br./ | MW |
| | (mol: | (mol: | Q | (mmol · | gTi) × | 1000 | × |
| | mol) | mol) | (%) | min)) | 10⁻⁶ | C | 10⁻⁴ |
| 1-C | 0 | 0 | 90.14 | 3192 | 2.4 | 9.5 | 4.7 |
| 2 | 1.2 | 0 | 90.79 | 3442 | 2.4 | 9.7 | 4.6 |
| 3 | 0 | 1.2 | 90.52 | 4071 | 2.9 | 8.6 | 5.0 |
| 4-C | 0 | 0 | 90.7 | 4247 | 3.0 | 8.9 | 4.9 |

Br = branches
MW= weight average molecular weight

### Example 2

The experiments of this example were completed in the same polymerization reactor described above in Example 1 and using the same catalyst system (except as noted below) and the same polymerization conditions.

The catalyst used in some experiments was the same as used in Example 1 (“CpTiNP(tBu)₃Me₂”) or the similar dichloride form, (“CpTiNP(tBu)₃Cl₂”), as indicated by “Cl₂” or “Me₂” under the “Catalyst” column in Table 2. The preparation of CpTiNP(tBu)₃Me₂ is described below.

At room temperature, 43.7 mL of MeMgBr (3.0M in diethyl ether, 131.1 mmol, 2.5 equiv.) was added dropwise (over 1 hr.) to a yellow solution of Cp(^{t}Bu₃PN)TiCl₂ (20.985 g, 52.4 mmol) in toluene (300 mL). At the end of the addition the reaction was dark green and was allowed to stir at r.t. overnight. All solvent was removed under vacuum and the green residue was slurried in 100 mL of toluene and then dried under vacuum. The green residue was re-slurried in a 50:50 mixture of heptane:toluene and filtered through celite. The filtrate was dried under vacuum leaving the product as a light green solid (16.647 g, 88% yield).

The same MAO and hindered phenol used in Example 1 were also used in these experiments. The molar ratios of the components were also the same in both examples (Al/Ti=80/1 and OH/Al=0.3/1.

The comparative experiments of this example used the same borate as used in Example 1 (Ph₃CB(C₆F₅)₄). The B/Ti mole ratio was 1.2/1.

The inventive experiments were conducted using an activator that is a complex of a long chain amine catalyst modifier and a borate. The preparation of the borate/amine complex is described below.

The long chain amine used in this example was prepared from a hydrogenated bis (long chain alkyl) methyl amine. The long chain alkyl groups are reported by the supplier to contain an average of 16-18 carbon atoms, so the amine may be represented by the formula (C₁₆₋₁₈)₂NMe.

The long chain amine, ARMEEN M2HT, (42.713 g, 81.967 mmol) was ground into fine pieces using a ceramic mortar and pestle, and then added to a 2 L round-bottom flask equipped with a stir bar. Cyclohexane (1 L) was added to the flask, and the mixture was stirred at 450 rpm until the ARMEEN fully dissolved, forming a clear colourless solution. Using a dropping funnel hydrochloric acid (80 mL, 1.0 M in H₂O, 80 mmol) was added dropwise to the stirring solution, turning it white and opaque. The solution was maintained at room temperature and stirred overnight, approximately 22 hr., during which the solution turned a lustrous white colour. Meanwhile, lithium tetrakis(pentafluorophenyl)borate ethyl etherate (62.421 g, 82.122 mmol) was dissolved in deionized water (500 mL), forming a white cloudy gel, which was stirred overnight, approximately 20 hr. The borate mixture was loaded into a dropping funnel and added slowly to the armeenium chloride slurry and stirred for 2 hr. After 2 hr., the mixture was poured into a 500 mL separatory funnel in portions, and the organic and aqueous layers were separated into 1 L Erlenmeyer flasks. The organic fraction was washed in 3 portions, each with brine (4×100 mL), and the combined organic fractions were collected in a 2 L Erlenmeyer flask. The combined organic fractions were dried overnight over magnesium sulfate. The solution was then filtered through a glass frit into a 1 L 3-necked round-bottom flask and the volume reduced to approximately 250 mL under vacuum. The beige, transparent solution was then quantitatively transferred to a 500 mL Schlenk flask and dried under vacuum. The final compound was a viscous caramel-coloured oil (77.523 g, 64.542 mmol, 79% yield) and is referred to as “ammonium borate” in Table 2.

The comparative experiments 10-C and 11-C were conducted using the same borate activator used in Example 1 and in the absence of any long chain amine modifier. Experiments 10-C and 11-C show that both of the Cl₂ and Me₂ forms of the catalyst provide good productivity and a polymer having a satisfactory molecular weight under the reported polymerization conditions. The weight percent of the (C₁₆₋₁₈)₂NMe amine to total catalyst was 1.74%.

Inventive experiments 12, 13 and 14 were conducted using the borate/long chain amine complex described above. The B/Ti mole ratio was 1.2/1. As shown in Table 2, these inventive experiments also provide good productivity and a satisfactory polymer under the reported polymerization conditions. In addition, the polymerization of experiments 12-14 were completed in a stable manner (no reactor upsets) and did not produce any visual evidence of reactor fouling under the reported polymerization conditions.

TABLE 2

| Run | Catalyst | | | Productivity | | | | |
|---|---|---|---|---|---|---|---|---|
| # | Form | Cocatalyst Form | Kp | (gPE/gTi) | Q (%) | Br./1000C | MW | Mw/Mn |
| 10-C | Cl₂ | Ph₃CB(C₆F₅)₄ | 2,727 | 1,978,893 | 89.66 | 7.9 | 51670 | 1.84 |
| 11-C | Me₂ | Ph₃CB(C₆F₅)₄ | 2,561 | 1,802,838 | 89.97 | 8.4 | 50182 | 1.67 |
| 12 | Cl₂ | Ammonium borate | 3,506 | 2,372,480 | 90.36 | 8.7 | 48918 | 1.93 |
| 13 | Me₂ | Ammonium borate | 2,727 | 1,978,893 | 89.66 | 8.6 | 50162 | 1.74 |
| 14 | Me₂ | Ammonium borate | 3,804 | 2,616,495 | 90.2 | 9.5 | 46977 | 1.68 |

Kp units are L/(mmol · minute)

### Polymer Analysis

Molecular weight information (M_{w} and Mₙ) and molecular weight distribution (M_{w}/Mₙ) were analyzed by gel permeation chromatography (GPC), using an instrument sold under the trade name “Waters 150c”, with 1,2,4-trichlorobenzene as the mobile phase at 140° C. The samples were prepared by dissolving the polymer in this solvent and were run without filtration. Molecular weights are expressed as polyethylene equivalents with a relative standard deviation of 2.9% for the number average molecular weight (“Mn”) and 5.0% for the weight average molecular weight (“Mw”). Polymer sample solutions (1 to 2 mg/mL) were prepared by heating the polymer in 1,2,4-trichlorobenzene (TCB) and rotating on a wheel for 4 hours at 150° C. in an oven. The antioxidant 2,6-di-tert-butyl-4-methylphenol (BHT) was added to the mixture in order to stabilize the polymer against oxidative degradation. The BHT concentration was 250 ppm. Sample solutions were chromatographed at 140° C. on a PL 220 high-temperature chromatography unit equipped with four Shodex columns (HT803, HT804, HT805 and HT806) using TCB as the mobile phase with a flow rate of 1.0 mL/minute, with a differential refractive index (DRI) as the concentration detector. BHT was added to the mobile phase at a concentration of 250 ppm to protect the columns from oxidative degradation. The sample injection volume was 200 mL. The raw data were processed with Cirrus GPC software. The columns were calibrated with narrow distribution polystyrene standards. The polystyrene molecular weights were converted to polyethylene molecular weights using the Mark-Houwink equation, as described in the ASTM standard test method D6474.

What is claimed is:

1. A polymerization process comprising contacting ethylene and at least one alpha olefin with a polymerization catalyst in a solution polymerization reactor, the polymerization catalyst comprising: i) a phosphinimine catalyst, ii) a cocatalyst, and iii) a catalyst modifier; wherein the catalyst modifier is comprising a long chain amine.

2. The process of claim 1 wherein the catalyst modifier comprises at least one compound represented by the formula: R¹N((CH₂)ₙOH)((CH₂)ₘOH) where R¹ is a hydrocarbyl group having from 5 to 30 carbon atoms, and n and m are integers from 1 to 20.

3. The process of claim 1 wherein the catalyst modifier comprises at least one compound represented by the formula: R¹N((CH₂)ₙOH)₂ where R¹ is a hydrocarbyl group having anywhere from 6 to 30 carbon atoms, and n is independently an integer from 1-20.

4. The process of claim 1 wherein the catalyst modifier comprises at least one compound represented by the formula: R¹N((CH₂)ₙOH)₂ where R¹ is a hydrocarbyl group having anywhere from 6 to 30 carbon atoms, and n is 2 or 3.

5. The process of claim 1 wherein the catalyst modifier comprises at least one compound represented by the formula: R¹N(CH₂CH₂OH)₂ where R¹ is a hydrocarbyl group having anywhere from 8 to 22 carbon atoms.

6. The process of claim 1 wherein the catalyst modifier comprises a compound represented by the formula: C₁₈H₃₇N(CH₂CH₂OH)₂.

7. The process of claim 1 wherein the catalyst modifier comprises compounds represented by the formulas: C₁₃H₂₇N(CH₂CH₂OH)₂ and C₁₅H₃₁N(CH₂CH₂OH)₂.

8. The process of claim 1 wherein the catalyst modifier is a mixture of compounds represented by the formula: R¹N(CH₂CH₂OH)₂ where R¹ is a hydrocarbyl group having anywhere from 8 to 18 carbon atoms.

9. The process of claim 1 wherein the phosphinimine catalyst has the formula: (L)(L)ₙ(Pl)ₘMXₚ where M is a transition metal selected from Ti, Hf, Zr; Pl is a phosphinimine ligand; L is a cyclopentadienyl-type ligand or a heteroatom ligand; X is an activatable ligand; m is 1 or 2; n is 0 or 1; and p is determined by the valency of the metal M.

10. The process of claim 9 wherein the phosphinimine catalyst has the formula: (L)(L)ₙ(Pl)ₘMXₚ where M is a transition metal selected from Ti, Hf, Zr; Pl is a phosphinimine ligand; L is a cyclopentadienyl-type ligand or a heteroatom ligand; X is an activatable ligand; m is 1 or 2; n is 0 or 1; and p is determined by the valency of the metal M.

11. The process of claim 1 wherein the phosphinimine catalyst has the formula: (1-C₆F₅CH₂-Indenyl)((t-Bu)₃P═N)TiX₂, where X is an activatable ligand.

12. The process of claim 1 wherein the cocatalyst is selected from ionic activators, alkylaluminoxanes and mixtures thereof.
